(19) United States
(12) Patent Application Publication
(10) Pub. No.: US 2022/0128026 A1
(43) Pub. Date: Apr. 28, 2022

(54) WIND TURBINE BASED ENERGY HARNESSING SYSTEM

(71) Applicant: Robert Craig Smith, Yelm, WA (US)

(72) Inventor: Robert Craig Smith, Yelm, WA (US)

(21) Appl. No.: 17/509,142

(22) Filed: Oct. 25, 2021

Related U.S. Application Data
(60) Provisional application No. 63/105,529, filed on Oct. 26, 2020.

(51) Int. Cl. F03D 3/00; F03D 9/11

(52) U.S. Cl. CPC F03D 3/005; F03D 9/11; H02J 3/381; F05B 2240/213; F05B 2240/212

(57) ABSTRACT

The present invention relates to spiral wind turbines and an energy-harnessing system. The system features a plurality of spiral wind turbines adapted to collect drag energy of moving vehicles and for converting the collected energy into electricity. The spiral wind turbines can also be installed for collecting air flow energy from heating vents on rooftops, smokestacks or similar structures. The system uses wind energy along with captured moving air or heated air energy for producing electric power using electric generators and storing same using storage batteries. The turbines are vertically rotating, and the method of attachment/installation will depend on the type of turbine and the location. The system allows federal, state, and local governments, as well as others, to generate electricity passively.

### CROSS-REFERENCE TO RELATED APPLICATION

The present application claims priority to, and the benefit of, U.S. Provisional Application No. 63/105,529, which was filed on Oct. 26, 2020 and is incorporated herein by reference in its entirety.

### FIELD OF THE INVENTION

The present invention relates generally to the field of wind power generator systems. More specifically, the present invention relates to an energy harnessing system featuring a plurality of spiral wind turbines adapted to capture drag energy of moving vehicles and for converting the collected energy into electricity. The spiral wind turbines can also be installed for collecting air flow energy from heating vents on rooftops, smokestacks or similar structures. The system uses wind energy along with captured moving air or heated air energy for producing electric power using electric generators and storing same using storage batteries. The turbines can be installed along roadways, bridges, tunnels, rooftops, smokestacks or similar structures and the method of attachment/installation will depend on the type of turbine and the location. Accordingly, the present disclosure makes specific reference thereto. Nonetheless, it is to be appreciated that aspects of the present invention are also equally applicable to other like applications, devices, and methods of manufacture.

### BACKGROUND

In general, power generation systems and especially electricity generation systems can be hydroelectric power generation, thermal power generation, nuclear power generation, solar power generation, biofuel power generation, and wind power generation using wind energy. Use of natural or renewable resources such as solar and wind decrease the need for coal fire, natural gas, nuclear plants, and other energy sources that produce harmful greenhouse gases. Further, use of radioactive substances is also reduced. Individuals have repeatedly highlighted the need for alternative methods of power production, for example, the wind, the sun, water or organic matter.

In particular, use of wind energy for producing energy depends on only the wind. Wind energy is a limitless purely domestic renewable energy that is freely available in the world. However, the wind power generation systems heretofore known, face some difficulty in its stability due to fluctuation in direction and speed of air. The wind is not available everywhere and many other movements of the air can be used in addition to the wind for producing energy which has not yet been implemented. Harnessing energy from artificial sources or residually from existing sources, rather than depending upon the naturally occurring winds, can be beneficial using existing wind turbines and existing wind energy capturing devices.

Wind turbines have been long used for harnessing wind energy and converting it into other types of energy, such as electricity. Wind turbines are typically stationary and installed in a permanent location to convert kinetic energy from the wind into electricity. However, such turbines have only been used for harnessing wind energy and not for use with moving air produced by other sources such as drag forces of vehicles or heated air rising from smokestacks. There is a need for using wind turbines, or fixed wind turbines, to be installed at various places to use residual sources of moving air along with wind for producing energy, such as electrical energy.

Cost-effective alternative means of energy harnessing is required by federal, state, and local governments, as well as others, to generate electricity in cities or even in remote areas as the current means for electricity are becoming inadequate due to ever increasing demand and inability of using some wind and solar energy devices in certain situations due to environmental and geographical constraints.

Therefore, there exists a long felt need in the art for an energy harnessing system that uses natural or residual sources of air movement in addition to the wind for energy production. There is also a long felt need in the art for an improved system that can use existing wind turbines, for example spirally-arranged blades. Additionally, there is a long felt need in the art for an improved energy conversation system that does not create pollution and includes minimal production and maintenance costs after installation. Moreover, there is a long felt need in the art for an improved system that allows wind turbines to be utilized in the collection of energy from artificial and/or residual sources. Furthermore, there is a long felt need in the art for an improved energy harnessing system that collects drag energy from passing vehicles or rising waste heat from machinery. Finally, there is a long felt need in the art for an improved energy system that can be installed along roadways, bridges, and tunnels to allow for the collection of moving air in addition to the wind.

The subject matter disclosed and claimed herein, in one potential embodiment thereof, comprises a moving air or drag energy harnessing system. The system includes a plurality of vertical axis wind turbines, a plurality of electricity generating components, and a plurality of electrical energy reservoirs. The wind turbines capture drag energy from moving air or airflow caused by one or more of passing vehicles, rising waste heat from machinery or rooftop heating vents or more, the electricity generating components receiving captured drag energy from the wind turbines for producing electricity or electrical power from the received drag energy. The plurality of electrical energy reservoirs store the produced electrical energy or electricity for further usage. The system can have one or more electricity generating components and one or more electrical energy reservoirs or storage batteries.

In this manner, the wind turbine system of the present invention accomplishes all of the forgoing objectives and provides users with a system to use wind turbines for the collection of energy from artificial sources such as drag energy from passing vehicles or rising waste heat from machinery, rooftop heating vents and many more. The wind turbines collect the wind energy in addition to the energy from artificial resources. The turbines designed to be installed along roadways, bridges, tunnels and along any other area from where the energy from moving air can be captured and allows federal, state and local governments, as well as others, to generate electricity with no production cost once installed.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a moving air or drag energy harnessing system. The system is designed to harness energy from moving air produced by existing sources in addition to the wind. The system further comprising a plurality of wind turbines, a plurality of electricity generating components and a plurality of electrical energy reservoirs. The wind turbines capture drag energy from moving air caused by one or more of passing vehicles, rising waste heat from machinery, rooftop heating vents or more. The electricity-generating components receiving captured drag energy from the wind turbines for producing electricity or electrical power from the received drag energy and the plurality of electrical energy reservoirs store the produced electrical energy or electricity for further usage. The wind turbines can be one or more of a spiral type including the Darrieus wind turbine and the Savonius wind turbine or conventional wind turbines. The Darrieus wind turbine is a type of vertical axis wind turbine (VAWT) used to generate electricity from wind energy. The turbine consists of a number of curved aerofoil blades, mounted on a rotating shaft or framework. The curvature of the blades allows the blade to be stressed only in tension at high-rotating speeds. Savonius wind turbines are a type of VAWT used for converting the force of the wind into torque on a rotating shaft. The turbine consists of a number of aerofoils, usually, but not always, vertically mounted on a rotating shaft or framework, either ground-stationed or tethered in airborne systems.

In accordance with another feature of the present invention, generated electrical power can be routed via electrical connections from the electricity-generating components for direct storage within, and then for later use from electrical energy reservoirs.

In yet another embodiment of the present invention, the wind turbines can be located along a highway for capturing drag energy from passing vehicles, wherein each turbine is a spiral turbine and produces a spiraled airflow from the captured drag energy from opposing directions for easy rotation of the vanes of the turbine.

In yet another embodiment of the present invention, each wind turbine is connected to one or more roadside lights for providing illumination to the roadside lights after converting the captured drag energy into electrical energy.

In yet another embodiment of the present invention, the wind turbines can be mounted on a rooftop directly or rotatably-mounted on top of a pole wherein the wind turbines capture heated air from the heating vents for harnessing energy.

In yet another embodiment of the present invention, an energy-harnessing system comprising of a plurality of spiral type wind turbines is disclosed. The wind turbines are installed along roadways, bridges, and tunnels for collecting drag energy of the airflow generated alongside the vehicles passing alongside the turbines. The system further comprising electric generators for converting drag energy into electricity and energy reservoirs for storing the electricity. The energy harnessing system allows federal, state and local governments, as well as others, to generate electricity with no production costs after installation.

In yet another embodiment of the present invention, a spiral-type wind turbine for capturing moving air is disclosed. The spiral-type wind turbine has spiral blades.

In yet another embodiment, each spiral wind turbine forms a spiraled airflow that does not oppose the motion of the passing vehicles and can use the drag energy of the vehicles passing alongside both sides of the turbines, when the turbines are installed along the central median of a highway.

In yet another embodiment of the present invention, each spiral wind turbine includes a vertically-rotating wind turbine that can be rotated in either direction along the vertical axis.

In yet another embodiment, each spiral wind turbine is generally about three feet tall and can be made from recyclable carbon fiber. The wind turbine can also be made of any tough and lightweight metal or a composite that is able to withstand harsh environments, while meeting the highest of standards. Further, it is believed that each spiral wind turbine can produce between approximately 400 watts and 20 kilowatts of electricity.

In yet another embodiment, a method for producing electricity from drag energy due to airflow alongside moving vehicles using a plurality of spiral wind turbines installed along a roadway or median is disclosed. The method includes the steps of collecting wind or drag energy generated from moving vehicles by the spiral wind turbines, converting the collected wind or drag energy into electricity by electric generators and using the electricity to illuminate traffic lights or roadway lights.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram of a wind turbine energy-harnessing system of the present invention in accordance with the disclosed architecture;

FIG. 2 illustrates a perspective view showing a plurality of spiral wind turbines installed on a median barrier of a roadway for collecting drag energy due to airflow of moving vehicles in accordance with the disclosed architecture;

FIG. 3 illustrates a perspective view showing a plurality of wind turbines installed on a bridge in accordance with the disclosed architecture;

FIG. 4 illustrates a perspective view showing the wind turbines installed along a railway track for capturing wind or airflow generated from a locomotive or train motion on the track and for generating electricity using a power grid in accordance with the disclosed architecture;

FIG. 5 illustrates a perspective view showing the spiral wind turbines installed on a rooftop having a plurality of heat vents in accordance with the disclosed architecture;

FIG. 6 illustrates a perspective view showing an exemplary wind turbine mounted on a roadway night light for illuminating the light in accordance with the disclosed architecture;

FIG. 7 illustrates a perspective view showing another exemplary embodiment of the wind turbine that can be used in the present invention for capturing wind and air movement in accordance with the disclosed architecture; and

FIG. 8 illustrates a flow chart showing exemplary steps performed for capturing air flow energy by wind turbines of the present invention and generating electrical power from the captured energy in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an energy-harnessing system that uses natural or residual sources of air movement in addition to the wind for energy production. There is also a long felt need in the art for an improved system that can use existing wind turbines, for example spirally-arranged blades. Additionally, there is a long felt need in the art for an improved energy conversation system that does not create pollution and includes minimal production and maintenance costs after installation. Moreover, there is a long felt need in the art for an improved system that allows wind turbines to be utilized in the collection of energy from artificial and/or residual sources. Furthermore, there is a long felt need in the art for an improved energy harnessing system that collects drag energy from passing vehicles or rising waste heat from machinery. Finally, there is a long felt need in the art for an improved energy system that can be installed along roadways, bridges and tunnels to allow for the collection of moving air in addition to the wind.

The present invention, in one exemplary embodiment, includes a novel energy-harnessing and electricity-generating system. The system comprising of a plurality of spiral-type wind turbines installed along roadways, bridges and tunnels for collecting drag energy of the airflow generated alongside the vehicles passing alongside the turbines. The system further comprising electric generators for converting drag energy into electricity and energy reservoirs for storing the electricity. The energy harnessing system allows federal, state, and local governments, as well as others, to generate electricity with minimal production and maintenance costs after installation.

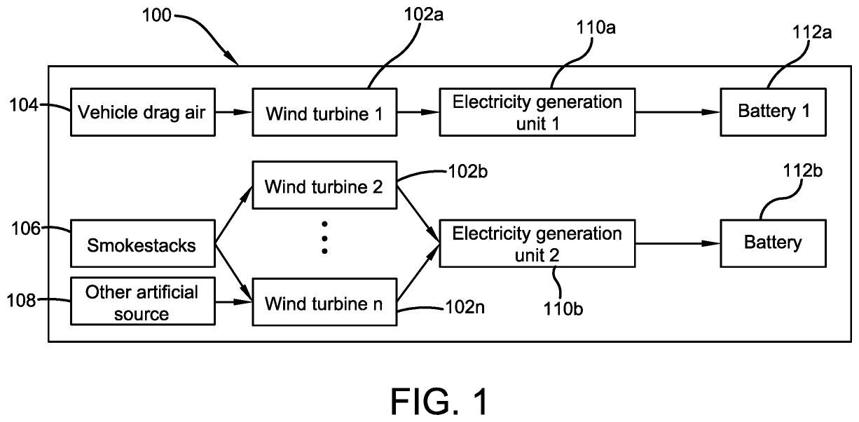

Referring initially to the drawings, FIG. 1 illustrates a block diagram of a wind turbine energy harnessing system 100 of the present invention in accordance with the disclosed architecture. The wind turbine energy-harvesting system 100 is designed to collect energy from a variety of sources such as vehicle drag air 104, smokestacks 106 or other residual sources 108, such as rising waste heat from machinery, or rooftop heating vents etc., for producing electricity. The wind turbine collecting energy system 100 includes a plurality of spiral wind turbines (102a, 102b, . . . , 102n). The spiral wind turbines can be any existing vertically-rotating wind turbines such as the Darrieus wind turbine, Savonius wind turbine or any other conventional wind turbines. The wind turbines (102a, 102b, . . . , 102n) can be installed in a specific area and can be installed on roads, highways, bridges, or tunnels that take advantage of the powerful wind or drag forces generated by the vehicle such as automobiles, motorcycles, trains, monorails and other types of vehicles passing alongside the turbines. The wind turbines (102a, 102b, . . . , 102n) can be installed at any convenient place where warm air or any residual air flow exists that can be used to rotate the wind turbine (102a, 102b, . . . , 102n). The wind turbines (102a, 102b, . . . , 102n) are configured to generate electricity from the kinetic energy of the wind experienced by the wind turbines (102a, 102b, . . . , 102n). For the simplicity, the wind turbines (102a, 102b, . . . , 102n) can be referred numerically as 102. The wind turbines 102 include a shape and size like a conventional wind turbine, for generating electricity from the kinetic energy of the wind experienced by the wind turbines. Alternatively, the wind turbines 102 can be of different shapes and sizes. Preferably, the wind turbines 102 are vertical axis wind turbines such that the axis of rotation of a wind turbine is perpendicular to the direction of wind flow. Such examples of known vertical axis wind turbines include the Darrieus wind turbine, the Savonius wind turbine and a Giromill. Any one of these types of wind turbines, or combinations or modifications of these wind turbines, can be implemented in the exemplary embodiments.

The wind turbines 102 installed along the roadways, or bridges and tunnels can collect vehicle drag energy 104 from the passing vehicles which leads to generation of the energy from airflow and drag energy of the moving vehicles. As shown as an example, the wind turbine 102a collects the vehicle drag air 104 and directs same to a first electricity generating unit 110a that generates electricity from the vehicle drag air 104. When the wind turbine 102a receives the vehicle drag air 104, the propeller-like blades of the turbine 102a around a rotor start rotating which spins a generator to create electricity.

The vehicle drag air 104 displaced by moving vehicles provides the kinetic energy that is collected by the blades of the turbine 102a and can be directed to the first electricity-generating unit 110a for generating electricity. The electricity generated by the electricity-generating unit 110a can be stored in the storage battery 112a for storage purposes. The battery 112a can be a lead battery that is used to store electricity generated by the wind power to reduce power fluctuations and increase reliability to deliver on-demand power. The battery 112a can also be a deep cycle battery that is popularly known for storing wind power.

Similarly, the wind turbine 102b can be installed at a different place such as on a rooftop to collects airflow energy generated from the smokestacks 106, or other artificial sources 108 such as heating vents on rooftops, rising waste heat from machinery, or other similar types of artificial sources. The air flow energy collected from the smokestacks 106, or other artificial sources 108 can be directed to the exemplary second electricity-generating unit 110b that generates electricity. The air flow energy collected from the smokestacks 106, or other artificial sources 108 leads to the rotation of blades that spins a generator to create electricity. The electricity/electric power generated by the electricity generating unit 110b is directed to the storage battery 112b for storage purposes. The battery 112b is similar to the battery 112a which can be used to store the electric power and ensure a steady supply of energy.

It should be understood that any number of wind turbines 102 installed in any configuration can form the system 100 of the present invention. The number of turbines, generators, and batteries depends on the requirements and system design criteria. In one case, the batteries may not be required as the generated electricity can power a source such as a traffic light, or roadway light in real-time.

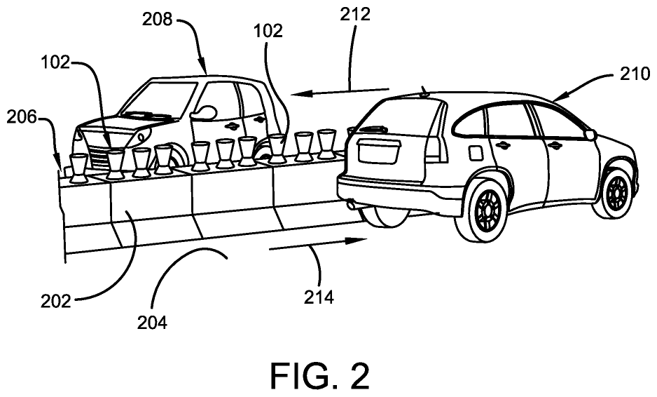

FIG. 2 illustrates a perspective view showing a plurality of spiral wind turbines 102 installed on a median barrier of a roadway for collecting drag or residual energy due to airflow of moving vehicles in accordance with the disclosed architecture. As shown in FIG. 2, a plurality of wind turbines 102 are mounted on the median barrier 202 between the first lane 204 and the opposing second lane 206. As stated earlier, the one or more wind turbines 102 can be spiral turbines or any other such type of turbines for capturing drag energy of the airflow caused by passing vehicles 208, 210 for generating electricity. When the vehicle 208, such as a car passes, the one or more wind turbines 102 rotate and capture drag or flow energy 212 of the moving car 208. The one or more spiral turbines 102 can be rotated in a counter-clockwise direction by the passing of the moving cars 208, 210 and thus produces a spiraled airflow from the captured drag energy 212 for easy rotation of the vanes of the turbine 102.

Similarly, when another vehicle 210 passes one or more wind turbines 102, the wind turbines 102 captures drag or flow energy 214 from the moving car 210. The one or more spiral turbines 102 are rotated in the counter-clockwise direction relative to the moving car 210, and accordingly produce a spiraled airflow from the captured drag energy 214 for easy rotation of the vanes of the turbine 102. The wind turbines 102 are configured to rotate and work in coordination with vehicles moving in both opposing lanes 204, 206 and thereby harness energy due to rotation caused by the motion of the vehicles 208, 210.

The mounted wind turbines 102 can be mounted atop or in the barrier 202 such that the turbines 102 are connected to one or more electricity generators and/or storage batteries as described in FIG. 1. The harnessed energy can be used for a multitude of applications such as illuminating traffic lights, roadway lights or providing electrical power to surveillance cameras. The turbines 102 can be connected to a central generator and battery through an electrical connection or can have individual electrical power generators and batteries as per the design criteria of the system for harnessing energy.

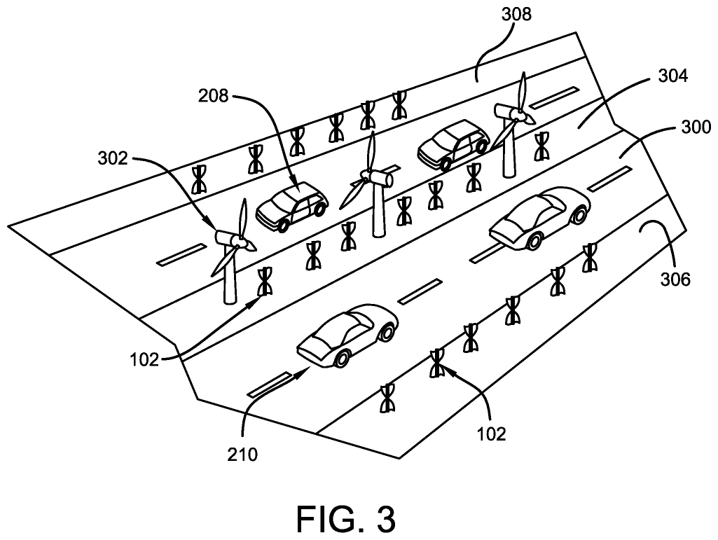

FIG. 3 illustrates a perspective view showing a plurality of wind turbines 102, 302 installed on a bridge 300 in accordance with the disclosed architecture. In the present embodiment, a plurality of spiral turbines 102 and a plurality of vertical wind turbines 302 can be installed along the bridge 300 for collecting airflow energy from the passing vehicles 208, 210 and for producing electricity as described in FIGS. 1 and 2. The vertical wind turbines 302 and the spiral wind turbines 102 can be mounted on the bridge median 304 and on the side walls 306, 308 of the bridge 300. The vertical wind turbines 302 are taller than the spiral turbines 102 and can be used for collecting the drag energy of taller vehicles.

Similarly, the spiral turbines 102 collect the drag energy from low-height vehicles. The one or more spiral turbines 102 produce a spiraled airflow from the captured drag energy for easy rotation of the vanes of the turbine 102.

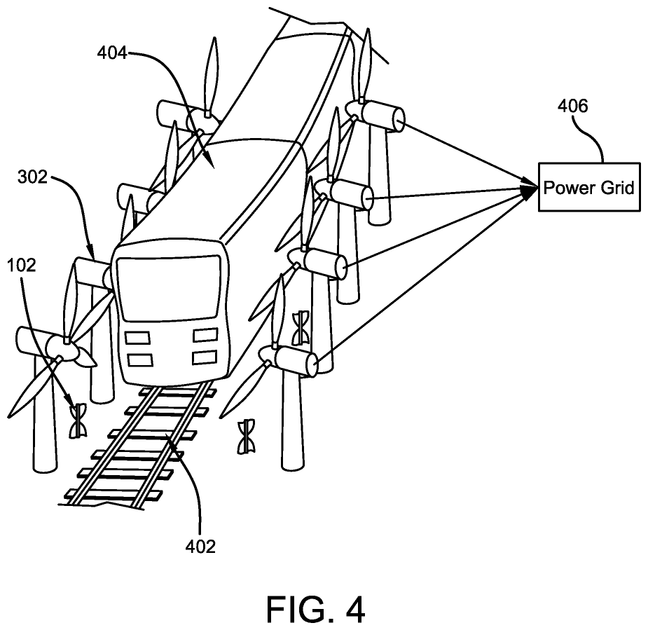

FIG. 4 illustrates a perspective view showing the wind turbines 102, 302 installed along a railway track 402 for capturing wind or airflow generated from a locomotive or train motion on the track 402 and for generating electricity using a power grid 406 in accordance with the disclosed architecture. The airflow caused by a train 404 running on a railway track 402 is very strong and can be a source for electricity. The wind turbines 102, 302, alone or in combination, can be installed along the track 402, thereby enabling the turbines to collect the drag energy or wind energy caused due to airflow created by the vehicle 404. Each of the turbines 102, 302 can be connected to a power grid 406, that can be installed by a federal, state and local government, for converting the captured energy into electrical power and for providing power for the required purposes. It should be noted that more than one power grid can be used for connecting to the turbines 102, 302.

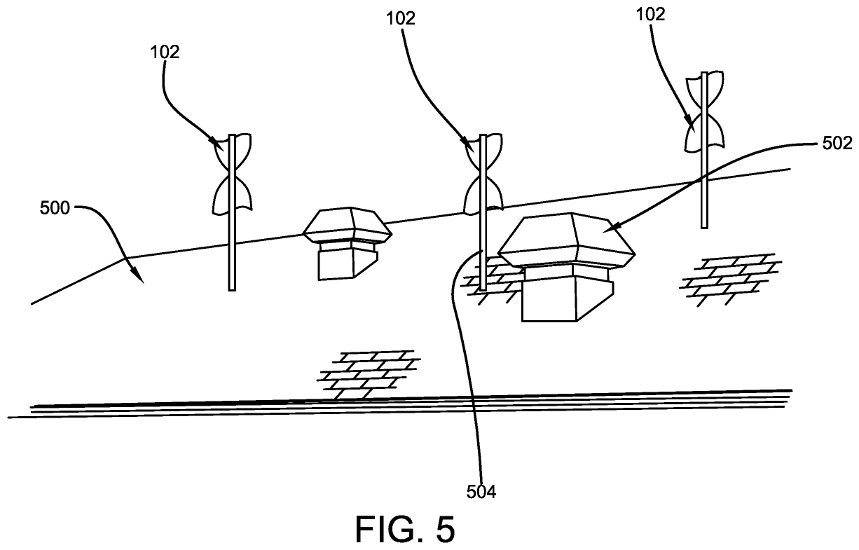

FIG. 5 illustrates a perspective view showing the spiral wind turbines 102 installed on a rooftop 500 having a plurality of heat vents 502 in accordance with the disclosed architecture. The wind turbines 102 of the energy-harnessing system 100 of the present invention can be used for capturing air flow of warm air exhausted by heat vents 502 disposed on the rooftop 500 of a manufacturing unit, for example. The turbines 102 collect the airflow from the heat vents 502 and use an integrated or coupled electric generator for producing electricity. The produced electricity can be used for providing continuous electrical power to any lighting apparatus or any other electrical component. The turbines 102 can be installed on the rooftop 500 directly, or can be mounted onto a pole 504 that is commercially available with the turbine 502.

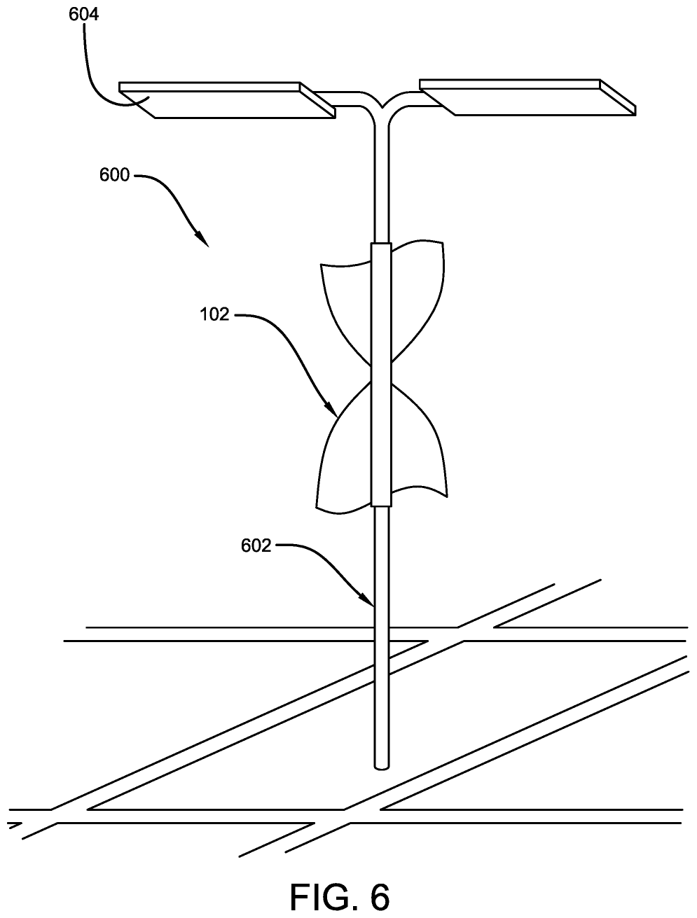

FIG. 6 illustrates a perspective view showing an exemplary wind turbine 102 mounted on a roadway night light 600 for illuminating the light 604 in accordance with the disclosed architecture. In the present embodiment, the wind turbine 102 is designed to be mounted onto a pole 602 of the roadway night light 600 such that the captured wind and airflow energy by the turbine 102 is converted into electricity by an integrated electric generator for illuminating the roadway illuminating light 604. The aforementioned eliminates the need to have a network of wires from the power grid connected to the traffic lights for illumination. Further, this eliminates the dependence on solar light and also on natural wind energy as generally thousands of vehicles can potentially pass through such lights, thereby creating a very large drag force that is captured by the wind turbine 102.

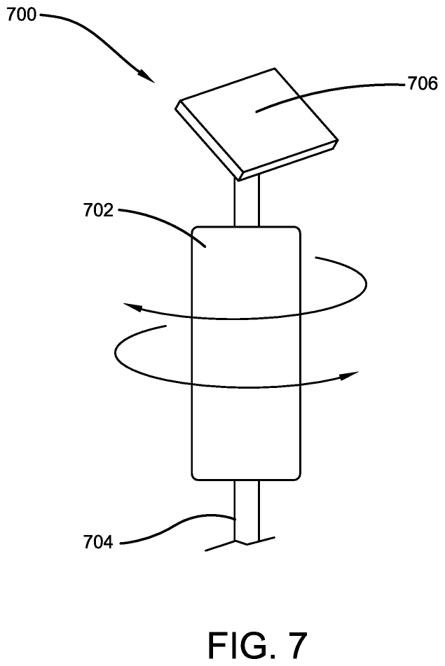

FIG. 7 illustrates a perspective view showing another exemplary embodiment of the wind turbine 700 that can be used in the present invention for capturing wind and air movement in accordance with the disclosed architecture. In the present embodiment, the turbine 700 has a cylindrical-rotating member 702 that can be rotated in both clockwise and counter-clockwise directions based on the direction and motion of vehicles passing alongside the turbine 700. The turbine 700 can include a pole 704 that can be installed in any surface for installing the turbine 700 thereon. The turbine 700 offers an added advantage of absorbing solar energy using the integrated solar panel 706, wherein electrical power can be generated from both the rotation of the rotating member 702 and the solar panel 706.

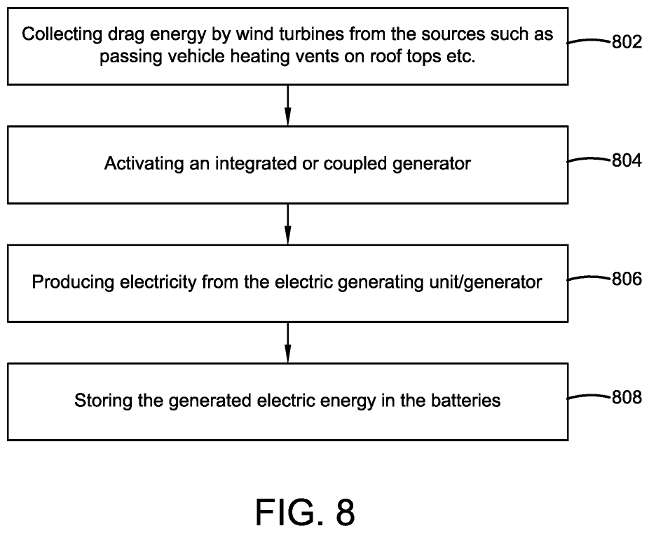

FIG. 8 illustrates a flow chart showing exemplary steps performed for capturing air flow energy by wind turbines of the present invention and generating electrical power from the captured energy in accordance with the disclosed architecture. Initially, drag energy caused by the airflow due to motion of the vehicles passing through the wind turbines is collected by the installed wind turbines. Similarly, air flow from other sources, such as heating vents and other sources, can also be collected (Block 802). Based on the collected energy, integrated or coupled electric generators are activated (Block 804). Thereafter, the collected energy is converted into electrical power by the electrical generator (Block 806). In some embodiments, a power grid can also be used for the purpose of producing electrical power. Finally, the electrical power is stored in the batteries (Block 808). Alternatively, the electrical power can be directly used for a desired purpose such as illuminating lights, providing power to surveillance cameras and many more.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wind turbine energy-harnessing system”, “wind turbine energy-harvesting system”, “energy system”, “wind turbine collecting energy system”, and “system” are interchangeable and refer to the wind turbine energy harnessing system 100 of the present invention. Similarly, as used herein “turbine”, “wind turbine”, “spiral wind turbine”, and “vertical wind turbine” are interchangeable and refer to the wind turbine 102, 302 of the present invention.

Notwithstanding the forgoing, the wind turbine energy harnessing system 100 and the wind turbine 102, 302 of the present invention can be of any suitable size and configuration as is known in the art without affecting the overall concept of the invention, provided that it accomplishes the above-stated objectives. One of ordinary skill in the art will appreciate that the size, configuration, and material of the wind turbine energy-harnessing system 100 and the wind turbine 102, 302 as shown in the FIGS. are for illustrative purposes only, and that many other sizes and shapes of the wind turbine energy-harnessing system 100 and the wind turbine 102, 302 are well within the scope of the present disclosure. Although the dimensions of the wind turbine energy harnessing system 100 and the wind turbine 102, 302 are important design parameters for user convenience, the wind turbine energy harnessing system 100 and the wind turbine 102, 302 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wind turbine energy harnessing system comprising:
a plurality of spiral wind turbines, wherein each of said plurality of spiral wind turbines is a vertically rotating wind turbine;
wherein said plurality of spiral wind turbines are mounted to a highway median;
wherein each of the vertically rotating wind turbines capture a drag force from a plurality of passing vehicles in opposing directions along a highway; and
further wherein said captured drag forces rotates each of said vertically rotating wind turbines in a clockwise or a counterclockwise rotation to generate a quantity of electricity.

2. The wind turbine energy harnessing system of claim 1, wherein said vertically rotating wind turbines include an axis of rotation that is perpendicular to a direction of wind flow.

3. The wind turbine energy harnessing system of claim 1, wherein said vertically rotating wind turbines are Darrieus turbines.

4. The wind turbine energy harnessing system of claim 1, wherein said vertically rotating wind turbines are Savonius turbines.

5. The wind turbine energy harnessing system of claim 2, wherein said vertically rotating wind turbines comprise a battery for storing the quantity of electricity.

6. The wind turbine energy harnessing system of claim 2 further comprising a second plurality of spiral wind turbines mounted to a second highway median.

7. The wind turbine energy harnessing system of claim 6, wherein the second plurality of spiral wind turbines capture other drag forces of passing vehicles in one direction, and further wherein said captured other drag forces rotate said second plurality of spiral wind turbines in a direction that is opposite to the direction of rotation of said vertically rotating wind turbines.

8. A method for harnessing wind energy from a plurality of passing vehicles, the method comprising the steps of:
mounting a plurality of spiral wind turbines to a highway median, wherein said plurality of spiral wind turbines are vertically rotating wind turbines;
capturing drag forces of the plurality of passing vehicles in opposing directions;
rotating said vertically rotating wind turbines in a counterclockwise direction from the plurality of passing vehicles;
generating electricity from said rotating of said vertically rotating wind turbines; and
storing the electricity in a battery.

9. The method of claim 8, wherein said vertically rotating wind turbines include an axis of rotation perpendicular to a direction of wind flow.

10. The method of claim 8, wherein said vertically rotating wind turbines are Darrieus turbines.

11. The method of claim 8, wherein said vertically rotating wind turbines are Savonius turbines.

12. The method of claim 9, wherein said passing vehicles are selected from a group consisting of a passenger car, a truck, and a train.

13. The method of claim 9, further comprising another plurality of said vertically rotating wind turbines mounted to another highway median.

14. The method of claim 13, wherein said another plurality of said vertically rotating wind turbines capture other drag forces of passing vehicles in one direction; and further wherein said captured other drag forces rotates said another plurality of said vertically rotating wind turbines clockwise to generate electricity.

15. A method for harnessing energy from a rooftop vent, the method comprising the steps of:
mounting a plurality of spiral wind turbines to a rooftop, wherein said spiral wind turbines are vertically rotating wind turbines;
capturing drag forces of vertically escaping air from said rooftop vent in said vertically rotating wind turbines;
rotating said vertically rotating wind turbines;
generating electricity from said rotating of said vertically rotating wind turbines; and
storing the electricity in a battery.

16. The method of claim 15, wherein said vertically rotating wind turbines include an axis of rotation aligned with a direction of said vertically escaping air.

17. The method of claim 15, wherein said vertically rotating wind turbines are Darrieus turbines.

18. The method of claim 15, wherein said vertically rotating wind turbines are Savonius turbines.

19. The method of claim 15, wherein said rooftop vent is a smokestack.

20. The method of claim 15, wherein said vertically escaping air is waste heat from machinery therebelow.
